(19) United States
(12) Patent Application Publication
(10) Pub. No.: US 2006/0291102 A1
(43) Pub. Date: Dec. 28, 2006

(54) SUSPENSION FOR MOUNTING MAGNETIC HEAD SLIDER, HEAD GIMBAL ASSEMBLY AND HARD DISK DRIVE

(75) Inventor: Takashi HONDA, Hong Kong (HK)

Correspondence Address: GREENBLUM & BERNSTEIN, P.L.C., 1950 ROLAND CLARKE PLACE, RESTON, VA, 20191, US

(73) Assignee: SAE MAGNETICS (H.K.) LTD., Hong Kong (HK)

(21) Appl. No.: 11/426,091

(22) Filed: Jun. 23, 2006

(30) Foreign Application Priority Data
Jun. 28, 2005 (JP) 2005-188239

(51) Int. Cl. G11B 5/48; G11B 21/16

(52) U.S. Cl. 360/245.7

(57) ABSTRACT

There is provided a suspension capable of suppressing deformation of a magnetic head slider mounted thereon. At the same time, there are provided high-quality head gimbal assembly and hard disk drive capable of achieving stable writing and reading of data. It is a suspension comprising a tongue face for mounting a magnetic head slider, wherein a deformation-difference absorbing device is provided on the tongue face for absorbing a difference between thermal deformations of the tongue face and the magnetic head slider.

### BACKGROUND OF THE INVENTION

1. Field of the Invention

The present invention relates to a suspension for loading a magnetic head slider and, more specifically, to a suspension capable of suppressing deformation of a magnetic head slider that is loaded thereon. Furthermore, the present invention relates to a head gimbal assembly and a hard disk drive which comprise the suspension.

2. Description of the Related Art

A head gimbal assembly to be loaded on a hard disk drive comprises a suspension for mounting a magnetic head slider that performs writing and reading of data to/from a magnetic disk. The suspension comprises a flexure 102 to which a magnetic head slider 101 is directly mounted. FIG. 10 shows the tip part of the flexure 102. FIG. 10A illustrates the top-face side of the flexure 102 on which the magnetic head slider is mounted, whereas FIG. 10B shows the back-face side thereof.

As shown in FIG. 10A, the flexure 102 of the conventional case has a thin-plate tongue face 121 with which almost an entire surface of one face of the magnetic head slider 101 comes in contact and fixed. The tongue face is also referred to as a gimbal whose one end is connected to the flexure 102, and the connection part exhibits a spring characteristic which functions to allow the loaded magnetic head slider 101 to keep a proper flying height with respect to the magnetic disk.

The tongue face 121 and the magnetic head slider 101 are securely fixed by an adhesive filled therebetween, for example. The tongue face 121 therefore has the adhesive applied thereon uniformly, Thus, the shape thereof is formed in a planar form as shown in Patent Literature 1 and FIG. 10.

Further, there are cases of using solder for fixing the magnetic head slider 101, whether or not the adhesive is used. For example, as shown in FIG. 10, the end face of the magnetic head slider 10 where a writing/reading element is formed and the opposite-side end face thereof, i.e. both end faces in the longitudinal direction of the roughly-cuboid magnetic head slider, are fixed to the tongue face 121 (suspension) through solders 141 and 142. In that state, the solder 141 is also used to connect a terminal of a wiring trace mounted on the flexure 121 and a terminal formed on the magnetic head slider 101.

[Patent Literature 1] Japanese Unexamined Patent Publication 2002-15536

However, if the thermal expansion coefficients of the magnetic head slider 101 and the flexure 102 are different, the magnetic head slider 101 may have a warp and distortion in accordance with deformation of the tongue face 121 caused by heat. FIG. 12 schematically shows an example thereof. As shown in FIG. 12A, when both ends (the end on the writing/reading element side and the opposite-side end) of the magnetic head slider 101 are connected to the tongue face 121 by the solders 141 and 142, the tongue face 121 shrinks and changes its shape as shown by arrows of FIG. 12B at a low temperature. In accordance with this, there is a warp (crown) generated in the magnetic head slider 101. In the meantime, the tongue face is extended as in arrows of FIG. 12C when the temperature increases, which also causes the magnetic head slider 101 to have a crown.

The deformation of the magnetic head slider described above can also happen in the case where the tongue face and the magnetic head slider are securely fixed by an adhesive. Furthermore, even with the use of a low-elastic epoxy adhesive that absorbs the thermal expansion difference of both members as disclosed in Patent Literature 1, it is not possible to cope with such deformation caused by an expansion difference of such an extent that cannot be absorbed by the adhesive. Particularly, this is not a technique for suppressing the deformation such as elongation and contraction of the tongue face. Thus, there may cause such an issue that the deformation of the tongue face affects the flying characteristic of the magnetic head slider.

Further, FIG. 11 shows a stress distribution of the thermal expansion caused in the flexure 102 when the flexure 102 in the shape of FIG. 10 is heated to 55° C. In this illustration, the part with lighter shading is where more stress is concentrated. From the illustration, it can be seen that the stress concentrates on the soldered part. Thus, the stress is also imposed on the magnetic head slider 101 that is fixed by solder at that soldered part. In other words, the stress may cause deformation of the magnetic head slider 101 as described above, and may change the spring characteristic of the flexure 102.

As described above, if the magnetic head slider and the tongue face have a crown, the flying characteristic of the magnetic head slider is affected. At the same time, there may change the pitch angle with respect to the magnetic disk due to a change in the angle for mounting to the suspension. If so, precision of writing and reading data to/from the magnetic disk may be deteriorated.

### SUMMARY OF THE INVENTION

An object of the present invention therefore is to improve the shortcomings of the above-described conventional case and, in particular, to provide a suspension capable of suppressing deformation of a loaded magnetic head slider. At the same time, it is an object of the present invention to provide high-quality head gimbal assembly and hard disk drive capable of achieving stable writing and reading of data.

The suspension as one form of the present invention is a suspension that comprises a tongue face for mounting a magnetic head slider, wherein a deformation-difference absorbing device is formed on the tongue face for absorbing a difference between thermal deformations of the tongue face and the magnetic head slider. Particularly, the deformation-difference absorbing device is characterized to absorb shrinking/expanding deformation of the tongue face with respect to the longitudinal direction of the magnetic head slider to be mounted thereon. The present invention is particularly suited for the case where the magnetic head slider is mounted to the tongue face by using solder alone.

With the present invention described above, first, if the thermal expansion coefficients of the suspension and the magnetic head slider itself are different, the tongue face and the magnetic head slider exhibit a different shrinking/expanding state from each other when heated. At that time, the deformation amount of the tongue face due to the shrinkage/expansion is absorbed by the deformation-difference absorbing device provided on the tongue face. This enables suppression of a crown, which is generated in accordance with the shrinkage/expansion of the tongue face, in the magnetic head slider that is fixed to the tongue face by an adhesive or the solder. Thus, it is possible to suppress deformation of the magnetic head slider and achieve stable writing and reading of data. As a result, quality of the products can be improved.

Further, the deformation-difference absorbing device is characterized as at least one through hole opened through the tongue face. Further, the through hole is desirable to be a closed slit-type hole formed in a closed-state within the tongue face or a one-end-open slit-type hole provided by being cut from a side-end of the tongue face with one end opened. Particularly, the through hole is characterized to be in a shape extended almost in parallel to a writing/reading-element-side end face of the mounted magnetic head slider.

By forming the through hole on the tongue face in the manner described above, the peripheral area of the though hole exhibits a spring characteristic. Thus, deformation of the tongue face by thermal expansion can be absorbed. At the same time, the strength in the peripheral area of the through hole becomes weak, so that the stress imposed on that area generated in accordance with the thermal expansion can be dispersed. Therefore, transmission of the stress to the magnetic head slider to be mounted thereon can be suppressed, resulting in suppression of the deformation thereof. Furthermore, by forming the through holes in various slit-type shapes as described above, the connection parts on the tongue face formed by the end parts of the slit-type holes in the longitudinal direction can be provided with more spring characteristic. Thus, deformation of the tongue face by thermal expansion can be more effectively absorbed. Particularly, in the case where the end face of the magnetic head slider on the writing/reading element side and the end face on the opposite side are fixed to the tongue face by solder, shrinkage/expansion of the tongue face almost in the vertical direction with respect to those end faces can be effectively absorbed. Therefore, deformation of the magnetic head slider can be more effectively suppressed.

Further, it is characterized in that a plurality of the same slit-type holes or a plurality of combinations of the slit-type holes are provided on the tongue face. In that state, the plurality of slit-type holes are arranged in such a manner that centers of the respective slit-type holes adjacent to each other are not lined on almost the same straight line with respect to the longitudinal direction of the magnetic head slider. Furthermore, the closed slit-type hole and the one-end-open slit-type hole are provided alternately on the tongue face. Moreover, the respective slit-type holes are provided in such a manner that a space between the respective slit-type holes adjacent to each other becomes narrow.

By providing a plurality of slit-type holes of the same shape or different shapes as described above, the number of end-part areas with the spring characteristic in the longitudinal direction of the slits is increased on the tongue face, and the stress can be dispersed as well. Thus, deformation of the tongue face by thermal expansion can be absorbed more. Particularly, by forming each slit-type hole in such a manner that the centers of slit-type holes adjacent to each other are not arranged on almost the same straight line with respect to the longitudinal direction of the tongue face or by setting the space between the slit-type holes, it is possible to absorb the deformation more effectively while maintaining the strength of the tongue face.

Further, another form of the present invention is a head gimbal assembly comprising the above-described suspension. Furthermore, still another form is a hard disk drive comprising the head gimbal assembly. By using the suspension of the above-described structure, a highly-reliable hard disk can be manufactured.

The present invention is structured and functions in the manner described above. With this, it is possible to suppress generation of a crown or the like on the magnetic head slider that is fixed and mounted to the tongue face, which is caused in accordance with shrinkage/expansion of the tongue face due to a difference between the thermal expansion coefficients of the tongue face and the magnetic head slider. Therefore, the present invention can achieve excellent effects that are not of the conventional case, i.e. it is possible to provide a suspension as well as a head gimbal assembly and a hard disk, which are capable of suppressing deformation of the magnetic head slider and achieving stable writing and reading of data.

### BRIEF DESCRIPTION OF THE DRAWINGS

FIG. 1 is an illustration for showing the structure of a flexure according to a first embodiment;

FIG. 2 is a stress contour of the flexure according to the first embodiment;

FIG. 3 is an illustration for showing the structure of a flexure according to a second embodiment;

FIG. 4 is a stress contour of the flexure according to the second embodiment;

FIG. 5 is an illustration for showing the structure of a flexure according to a third embodiment;

FIG. 6 is a stress contour of the flexure according to the third embodiment;

FIG. 7 is a graph for showing the amount of crown generated in a magnetic head slider in the case of using the flexure of the present invention and the case of using a flexure of a conventional case;

FIG. 8 is an illustration for showing the structure of a head stack assembly and a head gimbal assembly, to which the flexure of the present invention is mounted;

FIG. 9 is an illustration for showing the structure of a hard disk drive that uses the flexure of the present invention;

FIG. 10 illustrates the structure of the flexure according to a conventional case, in which FIG. 10A shows the side where the magnetic head slider is mounted while FIG. 10B shows the opposite side thereof;

FIG. 11 is a stress contour of the flexure of the conventional case; and

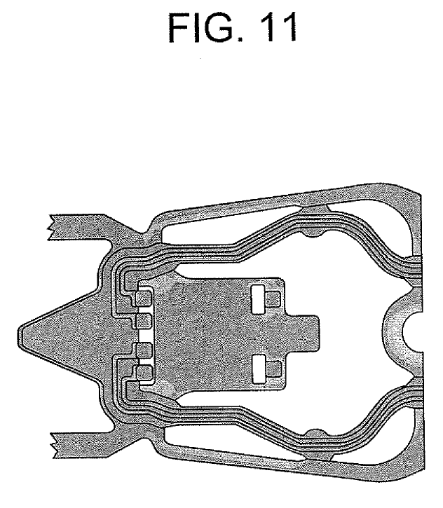

FIGS. 12A, 12B and 12C illustrate the state of thermal deformations of the flexure of the conventional case and the magnetic head slider mounted thereon.

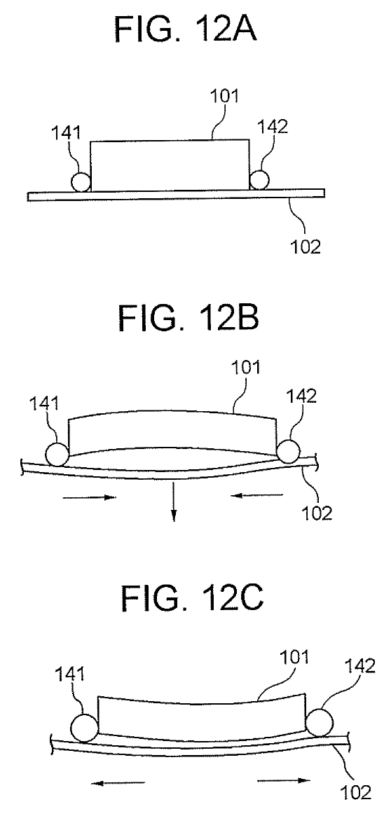

### DETAILED DESCRIPTION OF THE PREFERRED EMBODIMENTS

The present invention is characterized in that it absorbs thermal deformation of the mount part of a suspension to which a magnetic head slider is mounted. This allows absorption of a deformation difference, i.e. a thermal shrinkage difference or a thermal expansion difference, between the magnetic head slider and the suspension, which suppresses deformation such as a crown that may be generated in the magnetic head slider in accordance with the shrinkage and expansion of the suspension. As a result, it suppresses deterioration in the flying characteristic and the writing/reading precision. Specific structure and action will be described hereinafter by referring to the embodiments.

### First Embodiment

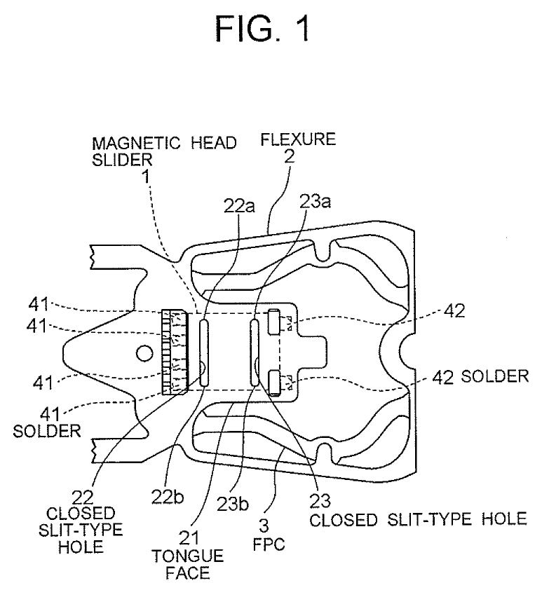

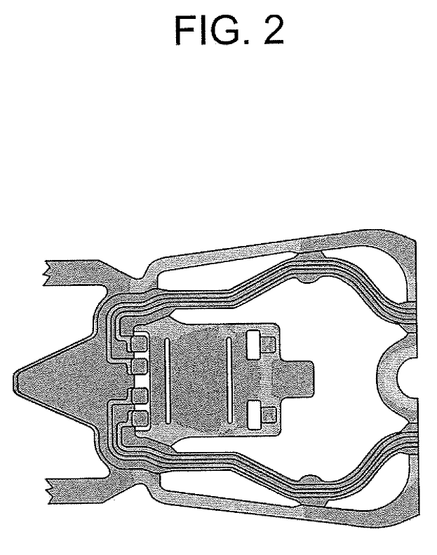

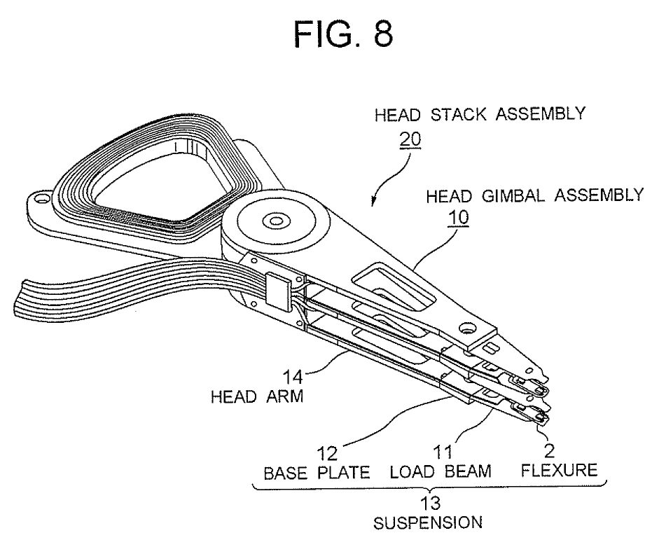

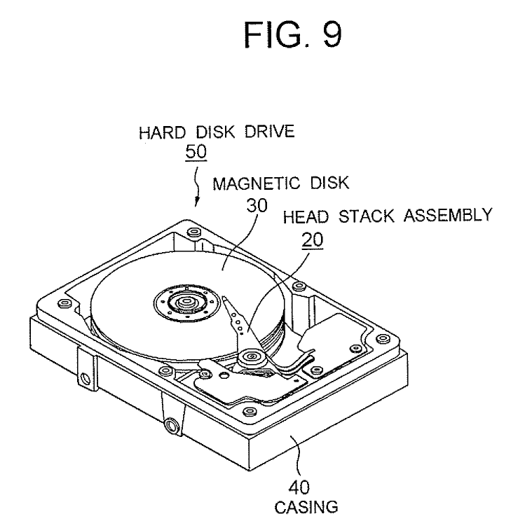

A first embodiment of the present invention will be described by referring to FIG. 1, FIG. 2, FIG. 8 and FIG. 9. FIG. 1 is an illustration for showing the structure of a suspension, and FIG. 2 is a stress contour when heated. FIG. 8 is an illustration for showing the structure of a head stack assembly that comprises a plurality of head gimbal assemblies to which the suspension is mounted, and FIG. 9 shows the structure of a hard disk drive to which the structure of FIG. 8 is loaded.

[Structure]

FIG. 1 shows the shape of a flexure 2 as a part of the suspension to which a magnetic head slider 1 is mounted. As shown in FIG. 8, the flexure 2 is fixed to a load beam 11 and, further, the load beam 11 is fixed to a base plate 12 for constituting a suspension 13. Further, the suspension 13 in such constitution is mounted on a head arm 14 through the base plate 12 for constituting a head gimbal assembly 10. Furthermore, each head arm 14 of a plurality of head gimbal assemblies 10 is supported axially to be rotationally driven by a voice coil motor for constituting a head stack assembly 20 (see FIG. 8).

Then, the above-described head stack assembly 20 is housed in a casing 40 that is equipped with a magnetic disk 30 for constituting a hard disk drive 50. The present invention is particularly distinctive in respect of the shape of the flexure 2 that is a part of the suspension. Thus, the flexure 2 will be described hereinafter. As described above, the shape of the flexure 2 shown in FIG. 8 is a schematic illustration. Therefore, it will be described in detail hereinafter by referring to FIG. 1.

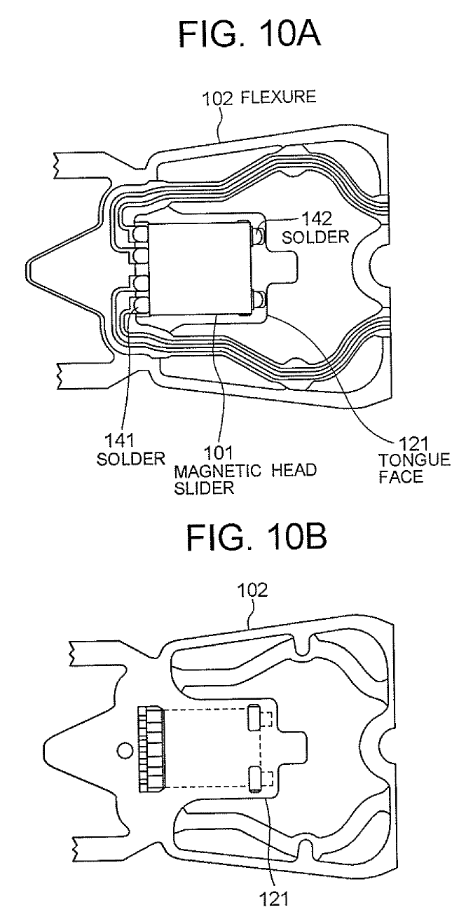

The flexure 2 of the embodiment shown in FIG. 1 employs almost the same structure as that of a conventional case shown in FIG. 10. That is, it is provided with roughly a rectangular-shape tongue face 21 for mounting the magnetic head slider 1, and the tongue face 21 is connected to the flexure main body at the top end (left side of FIG. 1) thus exhibiting a spring characteristic. The tongue face 21 therefore elastically changes its shape in the vertical direction, pitch direction, and roll direction of the magnetic head slider 1, thereby functioning to adjust the posture of the magnetic head slider properly when flying against the magnetic disk. In FIG. 1, the magnetic head slider 1 is mounted on the back-face side of the tongue face 21. Further, the roughly-rectangular tongue face 21 is formed with its longitudinal direction placed along the top- and rear-end direction, and it is assumed that the roughly-cuboid magnetic head slider 1 is also mounted along the longitudinal direction. However, the shape of the tongue face 21 is not limited to the one shown in the illustration.

Further, the magnetic head slider 1 is fixed to the tongue face 21 by solders 41 and 42. Specifically, both end faces in the longitudinal direction of the roughly-rectangular magnetic head slider 1 are soldered. More specifically, first, an FPC (Flexible Printed Circuit) 3 forming a trace wiring is provided to the flexure 2 on the side where the magnetic head slider 1 is mounted (see FIG. 10A) , on which a trace-side terminal is formed for exchanging data with the magnetic head slider 1. In accordance with this, a writing/reading element is mounted on an end face (left-side end face in FIG. 1) which is the top-end side when the magnetic head slider 1 is mounted to the flexure 2, and the magnetic-head-side terminal is formed for inputting and outputting the data thereto and therefrom. Thus, solder is used for connecting between each of the terminals (see reference numeral 41). That is, in this illustration, they are fixed by four points through the solder 41 in the top-end side (illustrated with broken lines). Furthermore, at the end face (right-side end face in FIG. 1) on the rear-end side of the magnetic head slider 1, solder is used for fixing the slider 1 itself to the flexure 2 (see reference numeral 42, illustrated with broken lines). That is, in this illustration, the slider 1 is fixed by two points on the rear-end side by the solder 42. The state of soldering is the same as that shown in FIG. 10A (reference numerals 141, 142).

As described, the magnetic head slider 1 is fixed to the flexure 2 by only by the solders 41 and 42 at both ends in the longitudinal direction. However, the magnetic head slider 1 may further be fixed to the tongue face 21 by an adhesive. Alternatively, it may be fixed only by the adhesive without using the solder.

On the tongue face 21 of the flexure 2 according to this embodiment, there are formed two slit-type holes 22 and 23 extending almost in parallel (vertical direction in FIG. 1) to the writing/reading-element-side end face of the magnetic bead slider 1 to be mounted thereon. In other words, there are groove-type through holes formed extending almost vertical with respect to the longitudinal direction of the tongue face 21. The slit-type holes 22, 23 have end parts 22a, 22b, 23a, 23b with respect to the longitudinal direction of the slits, positioned in the vicinity of both ends (each longer-side side) of the tongue face 21, which are provided enclosed within the tongue face 21. Thus, the slit-type hole in this shape is referred to as a closed slit-type hole hereinafter. With this, the areas in the vicinity of both ends of the tongue face 21 where the close slit-type holes 22 and 23 are formed come to have a spring characteristic.

FIG. 1 illustrates the case where the closed slit-type holes 22 and 23 are formed by extending almost vertically in the longitudinal direction of the tongue face 21. However, it is not limited to the closed slit-type holes 22 and 23 formed in that direction. Further, the shape of the through hole (slit-type hole) is not necessarily limited to the slit type (groove type with a prescribed length) but it may be in a circular shape, for example. Furthermore, although there are two closed slit-type holes 22 and 23 formed in FIG. 1, the through holes (slit-type holes or holes of other shapes) of more than that number may be formed. Alternatively, only one through hole may be formed.

[Action]

Next, action of the flexure in the above-described structure will be described by referring to FIGS. 1, 2 and FIG. 7. FIG. 2 shows a result of simulation of stress distribution on the flexure 2 imposed due to deformation such as thermal expansion when the temperature of the flexure 2, to which the magnetic head slider 1 is fixed by the solders 41 and 42, is increased to 55° C. with the reference temperature being at 25° C. The lighter concentration of shading indicates that there is the higher stress imposed thereupon. It is noted that the thermal expansion coefficient of the tongue face 21 of the flexure 2 and that of the magnetic head slider 1 itself herein are different.

When the flexure 2 is heated, the tongue face 21 and the magnetic head slider 1 expand respectively for a different length in accordance with a difference between the respective thermal expansion coefficients. Since the vicinity of both end parts 22a, 22b and 23a, 23b of the closed slit-type holes 22 and 23 of the tongue face 21 has a spring characteristic, expansion of the tongue face 21 is absorbed by that areas at the time of expansion. That is, even though the tongue face 21 expands in the longitudinal direction by heat and there is a tensile force worked for pulling it to the fixed points of the magnetic head slider 1 by the solders 41 and 42, this force is absorbed by the closed slit-type holes 22 and 23. Thus, the slit-type holes 22 and 23 function as a deformation-difference absorbing device for absorbing a difference between thermal deformations of the tongue face 21 and the magnetic head slider 1.

Referring to FIG. 2 that shows the stress imposed upon the flexure 2 at this time, the stress is concentrated on the vicinity of the end parts 22a, 22b, 23a, 23b of the closed slit-type holes 22 and 23 as well as the areas between those end parts (areas between the numeral references 22a and 23a, and between 22b and 23b). In other words, the stress in accordance with the thermal deformation imposed over the entire tongue face 21 is dispersed to those areas, so that it is also possible to suppress transmission of the stress to the magnetic head slider 1 to be mounted thereto. With this, deformation of the magnetic head slider 1 can also be suppressed effectively.

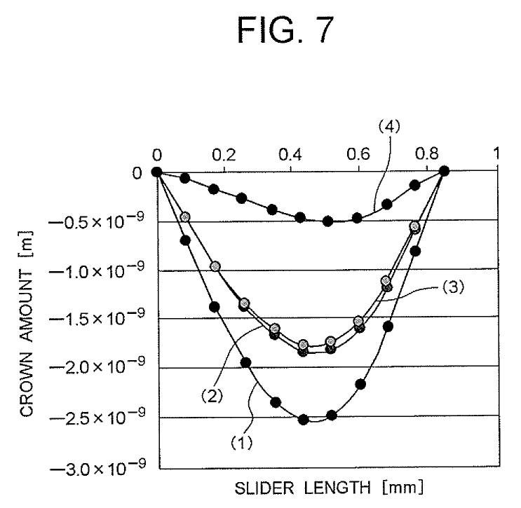

FIG. 7 is a graph showing the amount of warp (amount of crown) which indicates the amount of deformation of the magnetic head slider 1 compared to that of the conventional case. In the graph, the length of the magnetic head slider 1, i.e. the position in the longitudinal direction of the magnetic head slider 1, is taken as the horizontal axis and the crown amount is taken as the vertical axis

The curve (1) of FIG. 7 shows the crown amount of the magnetic head slider 1 of the conventional case provided with a regular tongue face 21, and the curve (2) shows the crown amount of the magnetic head slider 1 using the tongue face 21 having the structure of the embodiment. As can be seen from the comparison of those curves, the crown, i.e. deformation that can be generated in the magnetic head slider 1, can be effectively suppressed.

There has been illustrated the case where the tongue face 21 changes its shape in the expanding direction thereof by heat. However, it also applies to the case where the tongue face 21 shrinks by a temperature decrease and there works a force such that the areas between the fixed points of the magnetic head slider 1 by the solders 41 and 42 come closer. That is, a difference between the shrinkages of the magnetic head slider 1 and the tongue face 21 is absorbed by the closed slit-type holes 22 and 23 formed in the tongue face 21, so that the deformations of the tongue face 21 and the magnetic head slider 1 can be suppressed.

As described above, it is possible to suppress the crown to be generated in the magnetic head slider in accordance with the shrinkage/expansion of the tongue face to which the magnetic head slider is fixed by an adhesive or solder. Therefore, it is possible to achieve stable writing and reading of data by suppressing the deformation of the magnetic head slider, so that the quality of the product can be improved.

Unlike the case shown in FIG. 1, the centers of each closed slit-type hole may not be arranged on the same straight line along the longitudinal direction of the tongue face 21 when forming a plurality of closed slit-type lines 22 and 23. For example, when forming a plurality of the same closed slit-type holes 22 and 23 like the case of FIG. 1, the forming positions may be shifted from each other so that respective end parts 22a, 22b and 23a, 23b of the slit-type holes 22 and 23 are not lined on the same straight line along the longitudinal direction of the tongue face 21. In other words, each of the slit-type holes 22 and 23 may be formed by changing the slit length.

### Second Embodiment

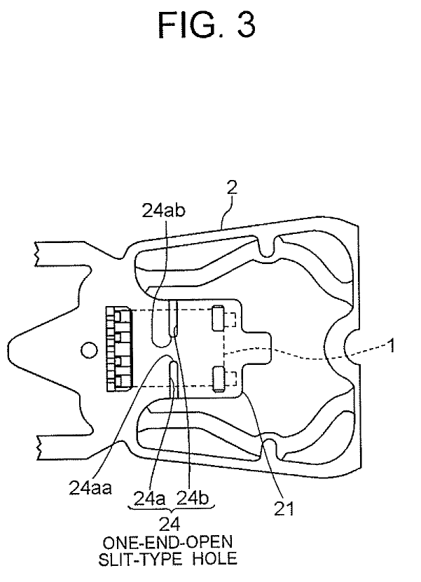

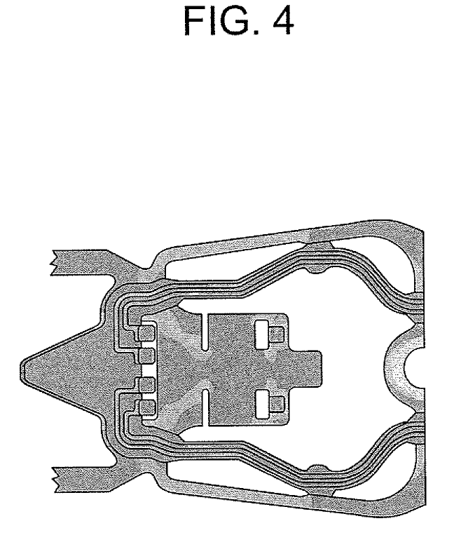

Next, a second embodiment of the present invention will be described by referring to FIG. 3 and FIG. 4. In this embodiment, the shape and position of the slit hole 24 formed in the tongue face 21 are different from those of the case described in the first embodiment.

[Structure]

As shown in FIG. 3, in this embodiment, there are formed slit-type holes 24 that are cut into the center from the ends on both sides of the tongue face 21. That is, this slit-type hole 24 is formed by being cut from the side-end of the tongue face 21 to be in a shape whose one end is open. In other words, it is separately formed into slit-type holes 24a and 24b, opening respectively towards the both side-ends from the vicinity of the center of the tongue face 21. Thus, end parts 24aa and 24ba of the respective sits in the longitudinal direction are positioned in the vicinity of the center of the tongue face 21, and the top-end side and the rear-end side of the tongue face 21 are connected by the area between those end parts 24aa and 24ba. Those slit-type holes 24a and 24b are referred to as one-end-open slit-type holes hereinafter.

The one-end-open slit-type holes 24a and 24b may not necessarily be formed as a pair as described above. It may be formed to open only on one of the side-ends. Further, there has been described above by referring to the case of forming the holes in almost the center in the longitudinal direction of the tongue face 21. However, they may be formed at other positions.

[Action]

Action of the flexure in the above-described structure will be described by referring to FIG. 3 and FIG. 4. Like the above-described case, FIG. 4 shows a result of simulation of stress distribution imposed on the flexure 2.

When the flexure 2 is heated (or cooled), the tongue face 21 and the magnetic head slider 1 respectively shrinks or expands for different lengths due to a difference between the respective thermal expansion coefficients. Since the connection part between the respective end parts 24aa, 24ba of the one-end-open slit-type holes 24a, 24b in the tongue face 21 exhibits a spring characteristic at that time, the shrinkage/expansion of the tongue face 21 are absorbed by that part. Further, when looking at the stress on the flexure 2 at this time by referring to FIG. 4, the stress is concentrated on the vicinity of the end parts 24aa, 24ba of the slits as well as the area from the base part that is the connection part between the tongue face 21 and the flexure main body towards the vicinity of the end parts 24aa, 24ba of the slits. In other words, the stress imposed over the entire tongue face 21 is dispersed to those areas, so that it is also possible to suppress transmission of the stress to the magnetic head slider 1 to be mounted thereto. With this, deformation of the magnetic head slider 1 can also be suppressed effectively.

FIG. 7 is a graph showing the amount of warp (amount of crown) which indicates the amount of deformation of the magnetic head slider 1 compared to that of the conventional case. Each of the axes represents the same as those described in the first embodiment. The curve (1) of FIG. 7 shows the crown amount of the magnetic head slider 1 of the conventional case provided with a regular tongue face 21, and the curve (3) shows the crown amount of the magnetic head slider 1 using the tongue face 21 having the structure of this embodiment. As can be seen from the comparison of those curves, the crown, i.e. deformation that can be generated in the magnetic head slider 1, can be effectively suppressed.

Unlike the case shown in FIG. 3, a plurality of pairs of one-end-open slit-type holes 24 may be formed in the tongue face 21. In that case, the centers of the pair of one-end-open slit-type holes, i.e. the connection part of the tongue ace 21, are better not to be arranged on the same straight line along the longitudinal direction of the tongue face 21. With this, the areas with the spring characteristic can be formed dispersedly on the tongue face 21, so that a high rigidity of the tongue face 21 can be maintained.

### Third Embodiment

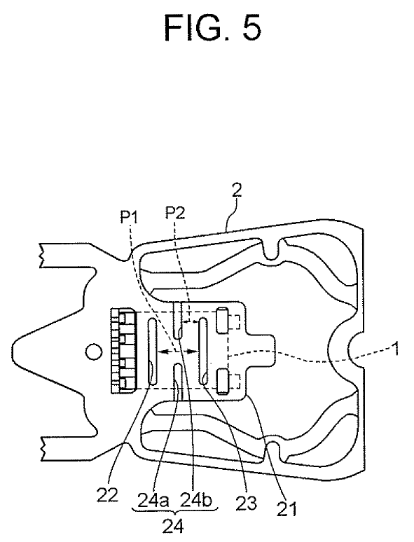

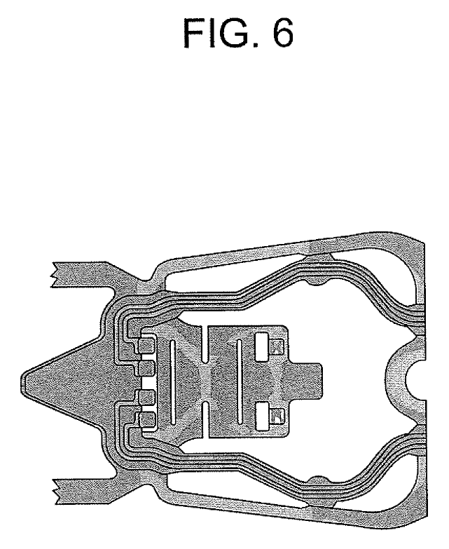

Next, a third embodiment of the present invention will be described by referring to FIG. 5 and FIG. 6. In this embodiment, the slit-type holes 22, 23 and 24 described in the first and second embodiments are combined. The detailed description will be provided hereinafter.

[Structure]

As shown in FIG. 5, in this embodiment, four slit-type holes 22, 23 and 24 (24a, 24b) are formed in the tongue face 21. Specifically, first, the closed slit-type holes 22 and 23 having the end parts 22a, 22b, 23a, 23b on the side-ends of the tongue face 21 described in the first embodiment are formed in the vicinity of the top end (in the vicinity of the base) of the tongue face 21 and in the vicinity of the rear end, respectively. Further, in almost the center in the longitudinal direction of the tongue face 21, there are formed a pair of one-end-open slit-type holes 24 (24a, 24b) which are formed by being cut from both side-ends towards the inner side and separated at the inner area.

By forming a plurality of slit-type holes (closed slit-type holes 22, 23, one-end-open slit-type holes 24) as described above, the space between each slit-type hole can be set narrower (see P1 and P2 of FIG. 5) as a result. The slit-type holes 22, 23 and 24 in different shapes are formed alternately so that end parts 22a, 22b, 23a, 23b, 24aa, 24ba of each slit (see FIG. 1, FIG. 3), i.e. the connection parts of the tongue face 21, are not arranged on the same straight line in the longitudinal direction of the tongue face. With this, the areas with the spring characteristic can be formed dispersedly on the tongue face, so that a high rigidity of the tongue face 21 can be maintained.

[Action]

Action of the flexure in the above-described structure will be described by referring to FIG. 5 and FIG. 6. Like the above-described case, FIG. 6 shows a result of simulation of stress distribution imposed on the flexure 2.

When the flexure 2 is heated (or cooled), the tongue face 21 and the magnetic head slider 1 respectively shrinks or expands for different lengths due to a difference between the respective thermal expansion coefficients. At that time, the vicinities of the respective end parts of the closed slit-type holes 22, 23 and the one-end-open slit-type holes 24 in the tongue face 21 exhibit the spring characteristic. There are a number of end parts of the respective slits formed on the side-ends and the center area of the tongue face 21, so that shrinkage/expansion of the tongue face 21 can be more effectively absorbed by the plurality of those end parts.

Further, when looking at the stress on the flexure 2 at this time by referring to FIG. 6, the stress is concentrated on the vicinity of the end parts of the respective slits as well as the areas between those end parts. In other words, the stress is dispersed over those areas, so that it is also possible to suppress transmission of the stress to the magnetic head slider 1 to be mounted thereto. With this, deformation of the magnetic head slider 1 can also be suppressed effectively. In the meantime, the rigidity of the tongue face 21 can be maintained high since the areas with the concentrated stress are formed dispersedly.

FIG. 7 is a graph showing the amount of warp (amount of crown) which indicates the amount of deformation of the magnetic head slider 1 compared to that of the conventional case. Each of the axes represents the same as those described in the first embodiment. The curve (1) of FIG. 7 shows the crown amount of the magnetic head slider 1 of the conventional case provided with a regular tongue face 21, and the curve (4) shows the crown amount of the magnetic head slider 1 using the tongue face 21 having the structure of this embodiment. As can be seen from the comparison of those curves, the crown, i.e. deformation that can be generated in the magnetic head slider 1, can be effectively suppressed. Particularly, it can be seen that this embodiment is capable of suppressing the crown amount even more effectively compared to the cases of other embodiments (curves (2) and (3)).

The positioning of the plurality of slit-type holes 22, 23 and 24 is not limited to the above-described combination. As described in the first and second embodiments, a plurality of the same-shape slit-type holes (the closed slit-type holes or the one-end-open slit-type holes) may be provided or an arbitrary number of slit-type holes of different shapes may be provided in combination. Furthermore, the position for providing each slit-type hole can be set arbitrarily. Particularly, it is preferable to design in such a manner that the centers of adjacent slit-type holes are not lined on almost the same straight line with respect to the longitudinal direction of the magnetic head slider. For example, even in the case where a plurality of the same-shape slit-type holes are provided, it is possible to suppress deformation effectively while maintaining the high rigidity of the tongue face as described above, through positioning the slit-type holes by shifting the centers thereof laterally with respect to the longitudinal direction.

### Fourth Embodiment

As shown in FIG. 8, a head gimbal assembly 10 can be manufactured by using the flexure 2 described in each of the aforementioned embodiments to which the magnetic head slider 1 is mounted. Furthermore, as shown in FIG. 9, a hard disk drive 50 to which the head gimbal assembly 10 is mounted can be manufactured.

With the hard disk drive 50 using the above-described flexure 2, thermal deformation such as a change in the crown of the magnetic had slider 1 due to the thermal expansion of the flexure 2 can be effectively suppressed. Thus, stable writing and reading of data can be achieved. Therefore, it is possible to improve the reliability and quality of the products.

The suspension according to the present invention can have a magnetic head slider that performs writing and reading of data to/from a magnetic disk mounted thereon, which can be loaded on a hard disk drive. Thus, it has an industrial applicability.

What is claimed is:

1. A suspension comprising a tongue face for mounting a magnetic head slider, wherein
a deformation-difference absorbing device is formed on said tongue face for absorbing a difference between thermal deformations of said tongue face and said magnetic head slider.

2. The suspension according to claim 1, wherein said deformation-difference absorbing device absorbs shrinking/expanding deformation of said tongue face with respect to a longitudinal direction of said magnetic head slider to be mounted thereon.

3. The suspension according to claim 1, wherein said magnetic head slider is mounted to said tongue face by using solder alone.

4. The suspension according to claim 1, wherein said deformation-difference absorbing device is at least one through hole opened through said tongue face.

5. The suspension according to claim 4, wherein said through hole is a closed slit-type hole formed in a closed-state within said tongue face or a one-end-open slit-type hole provided by being cut from a side-end of said tongue face with one end opened.

6. The suspension according to claim 4, wherein said through hole is in a shape extended almost in parallel to a writing/reading-element-side end face of said mounted magnetic head slider.

7. The suspension according to claim 5, wherein a plurality of same said slit-type holes or a plurality of combinations of said slit-type holes are provided on said tongue face.

8. The suspension according to claim 7, wherein said plurality of slit-type holes are arranged in such a manner that centers of said respective slit-type holes adjacent to each other are not lined on almost a same straight line with respect to a longitudinal direction of said magnetic head slider.

9. The suspension according to claim 7, wherein said closed slit-type hole and said one-end-open slit-type hole are provided alternately on said tongue face.

10. The suspension according to claim 7, wherein said respective slit-type holes are provided in such a manner that a space between said respective slit-type holes adjacent to each other becomes narrow.

11. A head gimbal assembly, comprising said suspension according to claim 1.

12. A hard disk drive, comprising said head gimbal assembly according to claim 11.
